(19) United States
(12) Patent Application Publication
(10) Pub. No.: US 2023/0051395 A1
(43) Pub. Date: Feb. 16, 2023

(54) SCOUT PULSING

(71) Applicant: ARGO AI, LLC, Pittsburgh, PA (US)

(72) Inventor: Samuel Richard Wilton, Levittown, PA (US)

(21) Appl. No.: 17/401,904

(22) Filed: Aug. 13, 2021

(51) Int. Cl. G01S 17/26; G01S 7/481; G01S 7/484; G01S 7/497

(52) U.S. Cl. CPC G01S 17/26; G01S 7/4817; G01S 7/484; G01S 7/497

(57) ABSTRACT

Disclosed herein are system and method embodiments to implement a scout pulse LiDAR. An embodiment operates by emitting a leading sequence of two or more discrete pulses with a constant timing offset and large intensity ratio. These leading pulses are each called a ‘scout pulse’ because they scout ahead of the primary pulse to detect high intensity targets, which would otherwise saturate the detector. In the simplest configuration, there are only two pulses, one primary pulse (lagging, high power/intensity) and one scout pulse (leading, low power/intensity). In more complex configurations, there may be any number of multiple scout pulses, each with a unique time delay and intensity. In any configuration, the signals are emitted in order of ascending intensity, with the lowest intensity signal in front (first), and the highest intensity signal in the back (last) within the pulse train.

### BACKGROUND

Light Detection and Ranging (LiDAR) is a sensing method that uses light in the form of a pulsed laser to measure ranges (variable distances) using reflected light. However, high intensity light that is reflected from highly reflective surfaces (e.g., street signs) can saturate a sensor (detector) that measures the reflected light. Saturation is a state in which a signal that needs to be measured is larger than a dynamic range of the sensor. When this happens, the output of the sensor becomes the limiting value of the sensor range and may be a source of considerable error between the true and estimated values during motion tracking.

One method of improving detection quality for high intensity signals is to simply reduce the reflected signal intensity by reducing laser power output, reducing detector sensitivity, reducing aperture size, etc. However, each of these methods may affect the return signal intensity for all pixels in an entire array, which may negatively impact the detection performance and quality of low intensity return signals.

Some LiDARs may employ laser power modulation on a pulse-by-pulse basis. Each individual pixel is coupled to its own laser, so intensity can be modulated selectively for individual pixels. Selectively reducing signal intensity on a pulse-by-pulse basis is a flawed approach because it requires assumptions about the expected signal intensity in a highly dynamic scene, and prevents the LiDAR from detecting lower intensity returns from diffused targets if the assumptions are incorrect. Complex scenes with alternating high and low intensity regions can confuse the system and introduce artifacts. In addition, laser intensity modulation cannot be implemented in some LiDAR configurations, such as a configuration where a single laser bar illuminates all pixels in the receiver simultaneously. As a result, a reduction in laser power will inappropriately modify the signal intensity for all targets in the field-of-view.

### BRIEF DESCRIPTION OF THE DRAWINGS

The accompanying drawings are incorporated herein and form a part of the specification.

FIG. 1 illustrates an exemplary autonomous vehicle system, in accordance with aspects of the disclosure.

FIG. 2 illustrates an exemplary architecture for a vehicle, in accordance with aspects of the disclosure.

FIG. 3 illustrates an exemplary architecture for a LiDAR system, in accordance with aspects of the disclosure.

FIG. 4 illustrates a LiDAR system with primary and scout pulses, according to some embodiments.

FIG. 5A illustrates a return signal histogram generated by a linear-mode APD with a non-saturated waveform, according to some embodiments.

FIG. 5B illustrates a return signal histogram generated by a linear-mode APD with a saturated waveform, according to some embodiments.

FIG. 6 illustrates a return signal histogram generated by a Geiger mode detector with a saturated waveform, according to some embodiments.

FIG. 7A illustrates a return signal histogram with a non-saturated waveform, according to some embodiments.

FIG. 7B illustrates a return signal histogram with a saturated primary pulse waveform and non-saturated secondary pulses, according to some embodiments.

FIG. 7C illustrates a return signal histogram with a saturated primary pulse waveform and saturated first secondary pulse and non-saturated second secondary pulse, according to some embodiments.

FIG. 8A illustrates another return signal histogram with a non-saturated waveform, according to some embodiments.

FIG. 8B illustrates another return signal histogram with a saturated primary pulse waveform and non-saturated secondary pulses, according to some embodiments.

FIG. 9A illustrates a return signal histogram generated by a Geiger mode detector with a saturated primary pulse waveform and saturated first secondary pulse and non-saturated second secondary pulse, according to some embodiments.

FIG. 9B illustrates a return signal histogram generated by a Geiger mode detector with a saturated primary pulse waveform and first saturated secondary pulse and second saturated secondary pulse, according to some embodiments.

FIG. 10A illustrates a single transmitter configuration, according to some embodiments.

FIG. 10B illustrates a multiple transmitter configuration, according to some embodiments.

FIG. 11 is a flow diagram of primary and secondary pulse transmission and reflection processing, according to some embodiments.

FIG. 12 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for emitting scout pulses in advance of a primary LiDAR pulse. LiDAR uses a pulsed laser to measure distances to, but not limited to, buildings, pedestrians, signs or other objects. It may use ultraviolet, visible, or a near-infrared source to sense objects. Light energy emitted by a LiDAR system is known as a pulse or transmitted waveform and light reflected from the object is known as return or reflected waveform.

LiDAR detection schemes may include “incoherent” or “direct energy” detection, which principally measures amplitude changes of the reflected light. Micropulse systems may utilize intermittent bursts of energy. They use considerably less laser energy, typically on the order of one microjoule, and are often “eye-safe”, meaning they can be used without safety precautions. Two main photodetector technologies are used in LiDAR: solid-state photodetectors, such as avalanche photodiodes, or photomultipliers. However, a sensitivity of the receiver (detector) is another parameter that may need to be balanced in a LiDAR design.

In flash LiDAR, the entire field of view is illuminated with a wide diverging laser beam in a single pulse. This is in contrast to conventional scanning LiDAR, which uses scanning LiDAR and may contain a 1D or 2D sensor array to acquire more than one point per scan position. In some embodiments, scanning LiDAR is any LiDAR, which utilizes a mechanical or solid-state scanner to increase the static field of view of the sensor.

The result is a camera that takes pictures of distance, instead of colors. Flash LiDAR may be advantageous, when compared to scanning LiDAR, when the camera, scene, or both are moving, since the entire scene is illuminated at the same time.

As with all forms of LiDAR, the onboard source of illumination makes flash LiDAR an active sensor. The signal that is returned is processed by a computing device using embedded algorithms to produce a nearly instantaneous 3-D rendering (drawing) of objects and terrain features within the field of view of the sensor. The laser pulse repetition frequency is sufficient for generating 3-D videos with high resolution and accuracy. The high frame rate of the sensor makes it a useful tool for a variety of applications that benefit from real-time visualization, such as driverless vehicle navigation. By immediately returning a 3D elevation mesh of target landscapes, a flash sensor can be used to identify objects such as pedestrians, buildings, road edges, signs, other vehicles, etc.

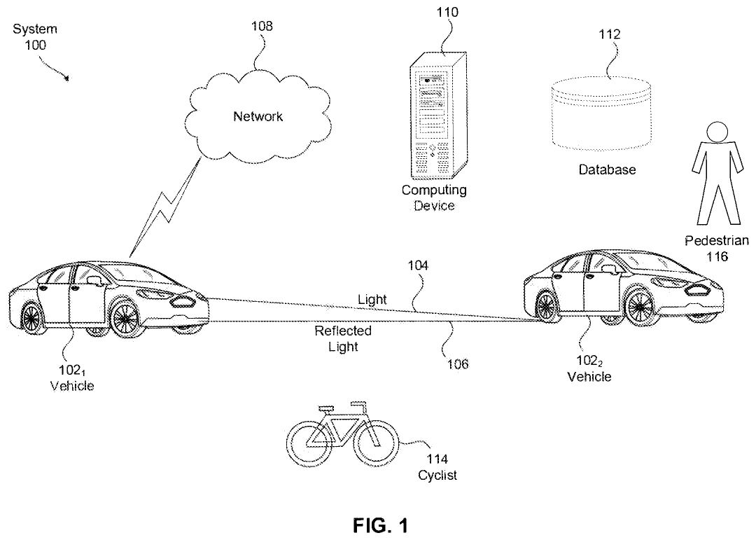

As will be described in FIGS. 1-4, mobile LiDAR (also mobile laser scanning) is when one or more scanners are attached to a moving vehicle to collect data along a path. These scanners may be paired with other kinds of equipment, including Global Navigation Satellite System (GNSS) receivers and Inertial Measurement Units (IMUs). One example application is mapping streets, where power lines, exact bridge heights, bordering trees, etc. all need to be taken into account. Instead of collecting each of these measurements individually in the field, in some embodiments, a 3-D model from a point cloud may be created where all of the measurements needed can be made, depending on the quality of the data collected. This eliminates the problem of forgetting to take a measurement, so long as the model is available, reliable and has an appropriate level of accuracy.

LiDAR mapping involves a process of occupancy grid map generation. The process involves an array of cells divided into grids, which employ a process to store the height values when LiDAR data falls into the respective grid cell. A binary map is then created by applying a particular threshold to the cell values for further processing. The next step is to process the radial distance and z-coordinates from each scan to identify which 3-D points correspond to each of the specified grid cell leading to the process of data formation.

The technology described herein, in some embodiments, transmits a leading sequence of two or more discrete pulses with a constant timing offset and a large intensity ratio. These leading pulses are each called a ‘scout pulse’ because they scout ahead of the primary pulse to detect high intensity targets, which would otherwise saturate the detector. In the simplest configuration, there are only two pulses, one primary pulse (lagging, high power/intensity) and one scout pulse (leading, low power/intensity). An absolute power level of the primary pulse may depend on the LiDAR architecture. In some embodiments, it could vary by more than six orders of magnitude (less than 1 microjoule to greater than 1 joule). The primary pulse is the nominal design power level of the system required to detect low reflectance objects at the maximum range of interest. A scaling factor between the primary pulse and the adjacent scout pulse(s) may, in an exemplary embodiment, be close to the dynamic range of the sensor. In a nominal case, the intensity ratio between adjacent pulses will be substantially equal to the dynamic range of the sensor. In some embodiments, a slightly higher scout pulse energy (e.g., ½ of the dynamic range of the sensor) may be selected so that the scout pulse can start to be observed prior to full saturation. In some embodiments, a substantially lower scout pulse energy, than that described throughout, may be selected (e.g., such that only retroreflective targets can be observed by the scout pulse for the purpose of retroreflector detection).

In some embodiments, if multiple scout pulses are used, the intensity ratio between the primary pulse and the lowest energy scout pulse will be roughly equal to DR\hat{ }N where DR is the dynamic range of the sensor and N is the number of scout pulses.

In more complex configurations, there may be any number of multiple scout pulses, each with a unique time delay and intensity. In any configuration, the signals are emitted in order of ascending intensity, with the lowest intensity signal in front (first), and the highest intensity signal in the back (last) within the pulse train.

The technology described herein, in some embodiments, generates a time delay between the scout pulse and a primary pulse. The time delay may be any value. In embodiments, the time delay should be as short as possible without mixing pulses together in a resultant return signal histogram. For Geiger-mode LiDAR, if more than one scout pulse is used, the time delay between each pulse must be unique to enable signal-processing algorithms to determine which of the N pulses caused saturation. Geiger-mode LiDAR utilizes a photo diode array to capture received light. Each diode in the array is sensitive enough to detect a single photon reflected from the illuminated area. In one embodiment, Geiger-mode LiDAR utilizes avalanche photodiodes, which are biased above the breakdown voltage of the device to detect single photons, but cannot directly measure the intensity of the light signal present in a single pixel from a single pulse. Per pixel light intensity may be estimated by statistically integrating multiple data frames. The dynamic range of the intensity estimate may be dependent on the number of integrated pulses.

Linear-mode LiDAR utilizes avalanche photodiodes, which require larger quantities of photons to detect the return signal, but are capable of directly measuring the return signal amplitude in a single pixel from a single pulse within the upper bound of the dynamic range of the detector.

In some embodiments, a scout pulse intensity ratio is nominally matched to the dynamic range of the receiver, e.g., for receiver with a dynamic range of 100:1, the scout pulse intensity ratio may be on the order of 100:1. In some instances, the scout pulse intensity ratio may be larger than the dynamic range of the receiver depending on the application. For example, if the receiver has an intrinsic dynamic range of 100:1, but is limited to only two scout pulses, it may be advantageous to use a scout pulse intensity ratio on the order of 3000:1 (e.g., if a primary goal is to measure the intensity of high-grade retroreflectors for the purpose of bloom mitigation). Blooming occurs on highly reflective objects. These objects may appear larger in the point cloud than they actually are due to unintended optical coupling between portions of the transmitted beam and receiver field of view. In this case, the intensity of diffuse targets will be detectable using the primary pulse, and the intensity of retroreflectors will be detectable using the scout pulse, but targets with intensities in-between, will be saturated by the primary pulse without the scout pulse being visible.

In some embodiments, the intensity dynamic range may increase by a power of the number of scout pulses. That is, if the nominal intensity dynamic range of the LiDAR is 100:1, and the system employs three scout pulses with an intensity ratio of 100×, the final dynamic range of the system is approximately 100³=1,000,000:1.

In some embodiments, high intensity LiDAR return signals, such as those generated by retroreflectors and specular surfaces, will saturate the waveform measured by a LiDAR detector. Saturation clips information, which signal-processing algorithms of a computing device require to make an accurate and precise determination of target range and intensity.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Notably, the present solution is being described herein in the context of an autonomous vehicle. The present solution is not limited to autonomous vehicle applications. The present solution can be used in other applications such as robotic application, radar system application, metric applications, and/or system performance applications.

FIG. 1 illustrates an exemplary autonomous vehicle system 100, in accordance with aspects of the disclosure. System 100 comprises a vehicle 102₁ that is traveling along a road in a semi-autonomous or autonomous manner. Vehicle 102₁ is also referred to herein as AV 102₁. AV 102₁ can include, but is not limited to, a land vehicle (as shown in FIG. 1), an aircraft, or a watercraft.

AV 102₁ is generally configured to detect objects (102₂, 114, 116) in proximity thereto. The objects can include, but are not limited to, a vehicle 102₂, cyclist 114 (such as a rider of a bicycle, electric scooter, motorcycle, or the like) and/or a pedestrian 116. When such a detection is made, AV 102₁ performs operations to generate one or more possible object trajectories for the detected object and analyze at least one of the generated possible object trajectories to determine whether or not there is an undesirable probability that a collision will occur between the AV and object in a threshold period of time (e.g., 1 minute). If so, the AV 102₁ performs operations to determine whether the collision can be avoided if a given vehicle trajectory is followed by the AV 102₁ and any one of a plurality of dynamically generated emergency maneuvers is performed in pre-defined time period (e.g., N milliseconds). If the collision can be avoided, then the AV 102₁ takes no action or optionally performs a cautious maneuver (e.g., mildly slows down). In contrast, if the collision cannot be avoided, then the AV 102₁ immediately takes an emergency maneuver (e.g., brakes and/or changes direction of travel). Other approaches to collision detection and avoidance by AV 102₁ are contemplated by this disclosure as would be understood by one skilled in the relevant art.

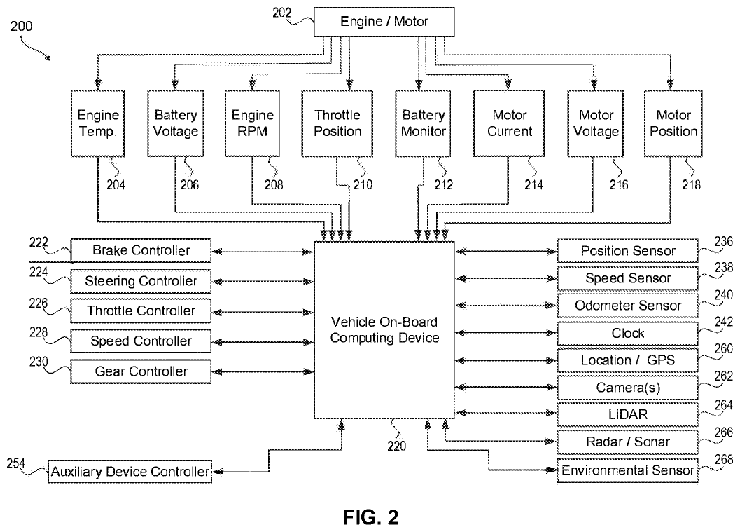

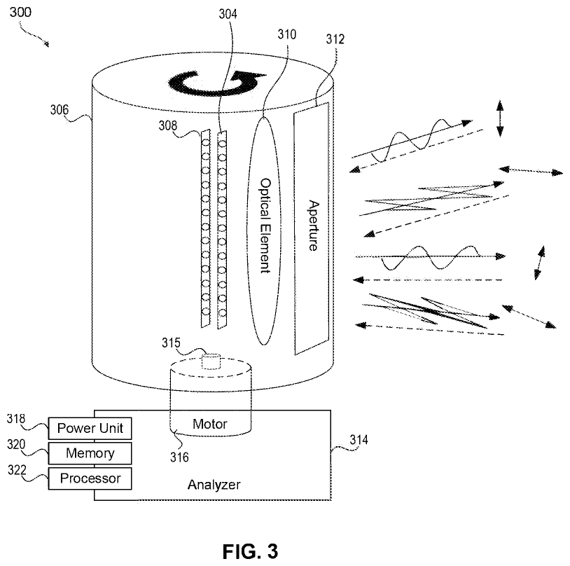

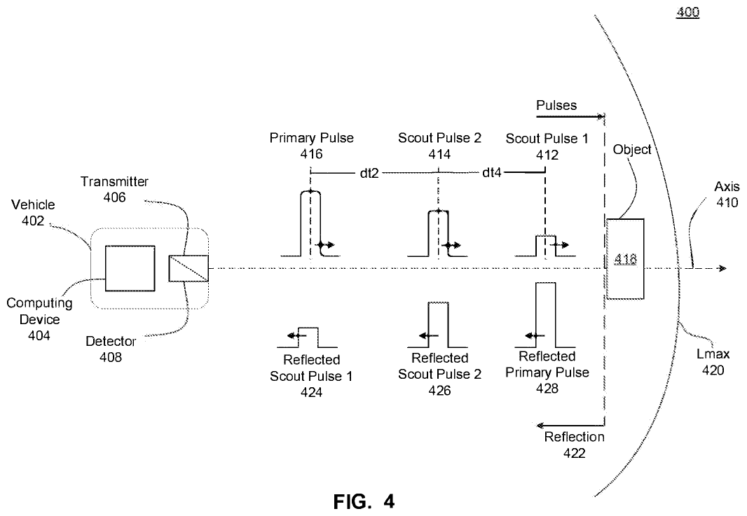

As will be described in greater detail in association with FIG. 3 and FIG. 4, AV 102₁ is configured with a LiDAR system 300. LiDAR system 300 may include a light emitter system 304 (transmitter) that transmits a light pulse 104 to detect objects located within a distance or range of distances of AV 102₁. Light pulse 104 may be incident on one or more objects (e.g., AV 102₂) and be reflected back to LiDAR system 300. Reflected light pulse 106 incident on light a detector 308 is processed by LiDAR system 300 to determine a distance of that object to AV 102₁. Light detector 308 may, in some embodiments, contain a photodetector or array of photodetectors positioned and configured to receive the light reflected back into the system. LiDAR information, such as detected object data, is communicated from LiDAR system 300 to an on-board computing device 220 (FIG. 2). AV 102₁ may also communicate LiDAR data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102₁ over network 108, to/from server(s) and/or database(s) 112.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102₁ may retrieve, receive, display, and edit information generated from a local application or delivered via network 108 from database 112. Database 112 may be configured to store and supply raw data, indexed data, structured data, map data, program instructions or other configurations as is known.

FIG. 2 illustrates an exemplary system architecture 200 for a vehicle, in accordance with aspects of the disclosure. Vehicles 102₁ and/or 102₂ of FIG. 1 can have the same or similar system architecture as that shown in FIG. 2. Thus, the following discussion of system architecture 200 is sufficient for understanding vehicle(s) 102₁, 102₂ of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and voltage 216 sensors, and motor position sensors 218, such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a LiDAR system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

During operations, information is communicated from the sensors to a vehicle on-board computing device 220. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as LiDAR system 264 is communicated from those sensors) to the vehicle on-board computing device 220. The object detection information and/or captured images are processed by the vehicle on-board computing device 220 to detect objects in proximity to the vehicle. Any known or to be known technique for making an object detection based on sensor data and/or captured images can be used in the embodiments disclosed in this document.

LiDAR information is communicated from LiDAR system 264 to the on-board computing device 220. Additionally, captured images are communicated from the camera(s) 262 to the vehicle on-board computing device 220. The LiDAR information and/or captured images are processed by the vehicle on-board computing device 220 to detect objects in proximity to the vehicle 200. The manner in which the object detections are made by the vehicle on-board computing device 220 includes such capabilities detailed in this disclosure.

When the vehicle on-board computing device 220 detects a moving object, the vehicle on-board computing device 220 generates one or more possible object trajectories for the detected object, and analyze the possible object trajectories to assess the probability of a collision between the object and the AV. If the probability exceeds an acceptable threshold, the vehicle on-board computing device 220 performs operations to determine whether the collision can be avoided if the AV follows a defined vehicle trajectory and/or implements one or more dynamically generated emergency maneuvers is performed in a pre-defined time period (e.g., N milliseconds). If the collision can be avoided, then the vehicle on-board computing device 220 may cause the vehicle to perform a cautious maneuver (e.g., mildly slow down, accelerate, or swerve). In contrast, if the collision cannot be avoided, then the vehicle on-board computing device 220 causes the vehicle to take an emergency maneuver (e.g., brake and/or change direction of travel).

FIG. 3 illustrates an exemplary architecture for a LiDAR system 300, in accordance with aspects of the disclosure. LiDAR system 264 of FIG. 2 may be the same as or substantially similar to the LiDAR system 300. As such, the discussion of LiDAR system 300 is sufficient for understanding LiDAR system 264 of FIG. 2.

As shown in FIG. 3, the LiDAR system 300 includes a housing 306, which may be rotatable 360° about a central axis such as hub or axle 315 of motor 316. The housing may include an emitter/receiver aperture 312 made of a material transparent to light. Although a single aperture is shown in FIG. 2, the present solution is not limited in this regard. In other scenarios, multiple apertures for emitting and/or receiving light may be provided. Either way, the LiDAR system 300 can emit light through one or more of the aperture(s) 312 and receive reflected light back toward one or more of the aperture(s) 312 as the housing 306 rotates around the internal components. In an alternative scenario, the outer shell of housing 306 may be a stationary dome, at least partially made of a material that is transparent to light, with rotatable components inside of the housing 306.

Inside the rotating shell or stationary dome is a light emitter system 304 that is configured and positioned to generate and emit pulses of light through the aperture 312 or through the transparent dome of the housing 306 via one or more laser emitter chips or other light emitting devices. The light emitter system 304 may include any number of individual emitters (e.g., 8 emitters, 64 emitters, or 128 emitters). The emitters may emit light of substantially the same intensity or of varying intensities. The individual beams emitted by the light emitter system 304 have a well-defined state of polarization that is not the same across the entire array. As an example, some beams may have vertical polarization and other beams may have horizontal polarization. The LiDAR system also includes a light detector 308 containing a photodetector or array of photodetectors positioned and configured to receive light reflected back into the system. The light emitter system 304 and light detector 308 would rotate with the rotating shell, or they would rotate inside the stationary dome of the housing 306. One or more optical element structures 310 may be positioned in front of the light emitter system 304 and/or the light detector 308 to serve as one or more lenses or waveplates that focus and direct light that is passed through the optical element structure 310.

One or more optical element structures 310 may be positioned in front of a mirror (not shown) to focus and direct light that is passed through the optical element structure 310. As shown below, the system includes an optical element structure 310 positioned in front of the mirror and connected to the rotating elements of the system so that the optical element structure 310 rotates with the mirror. Alternatively or in addition, the optical element structure 310 may include multiple such structures (for example lenses and/or waveplates). Optionally, multiple optical element structures 310 may be arranged in an array on or integral with the shell portion of the housing 306.

Optionally, each optical element structure 310 may include a beam splitter (not shown) that separates light that the system receives from light that the system generates. The beam splitter may include, for example, a quarter-wave or half-wave waveplate to perform the separation and ensure that received light is directed to the receiver unit rather than to the enmitter system (which could occur without such a waveplate, as the emitted light and received light should exhibit the same or similar polarizations).

LiDAR system 300 includes a power unit 318 to power the light emitter system 304, a motor 316, and electronic components. LiDAR system 300 also includes an analyzer 314 with elements such as a processor 322 and non-transitory computer-readable memory 320 containing programming instructions that are configured to enable the system to receive data collected by the light detector unit, analyze it to measure characteristics of the light received, and generate information that a connected system can use to make decisions about operating in an environment from which the data was collected. Optionally, the analyzer 314 may be integral with the LiDAR system 300 as shown, or some or all of it may be external to the LiDAR system and communicatively connected to the LiDAR system via a wired or wireless communication network or link.

FIG. 4 illustrates a LiDAR vehicle 402 mounted system with primary and scout pulses, according to some embodiments. In an exemplary embodiment, the LiDAR system may implement scout pulsing to improve LiDAR performance for high intensity return signals by emitting one or more very low intensity scout pulses in advance of the primary pulse. These scout pulses may be configured with an intensity ratio between adjacent pulses approximately equal to the dynamic range of the detector. If a reflected primary pulse causes detector saturation, a non-saturated scout pulse can be analyzed in place of the primary pulse to extend dynamic range, reduce range bias, and improve range precision.

LiDAR system 400, vehicle system 402, computing device 404, transmitter 406, detector 408, and object 418 may be the same as or substantially similar to the same elements as shown FIGS. 1-3. As shown, a light detection and ranging (LiDAR) system 400 includes a first light emitting element (transmitter) 406 operable to emit one or more low intensity light beams (i.e., scout pulses 412 and 414). In some embodiments, one or more low intensity scout pulses (lowest intensity first, with subsequent pulses increasing in intensity) may comprise multiple adjacent low intensity scout pulses (scout pulses 412 and 414) configured with an intensity ratio between adjacent low intensity pluses (scout pulse 1 and scout pulse 2) substantially equal to a dynamic range of the light detecting element. The one or more low intensity scout pulses may comprise multiple adjacent low intensity scout pulses separated by a unique time delay (e.g., dt1 or dt2), comprise a unique intensity and be emitted in an order of ascending intensity, lowest intensity to highest intensity (but not higher than the primary pulse). In addition, an intensity dynamic range of detector 408 may be increased by a power of the number of the multiple adjacent low intensity scout pulses.

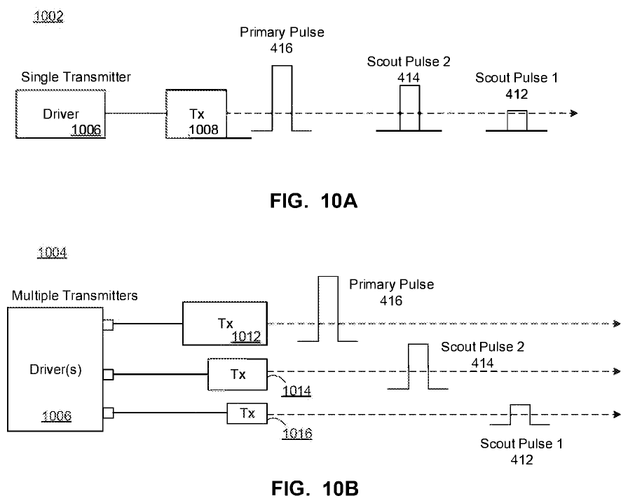

In one aspect, the first light emitting element and the second light emitting element share a common transmitter 406 with electronically tunable time delays to emit the one or more low intensity light beams and the high intensity light beam (see FIG. 10A). In another aspect, the first light emitting element and the second light emitting element are implemented as separate transmitters (see FIG. 10B) with electronically tunable time delays to emit the one or more low intensity light beams and the high intensity light beam. The separate transmitters may be calibrated to match an intended low intensity light beam pulse energy and the tunable time delays between each transmitter are electronically reconfigurable. In one aspect, the separate transmitters may be physically separated in a vertical plane and optically aligned by optical beam combining. For example, the transmitter 406 may be configured as a multi-transmitter unit with a second light emitting element (transmitter) operable to emit a high intensity light beam (primary pulse 416), where the high intensity light beam is emitted subsequent in time to the one or more low intensity light beams (scout pulses 412 and 414).

A light detecting element detector 408 is configured to detect reflected light beams 422. The reflected light beams 422 may include one or more scout pulses and a primary pulse. For example, the reflected light beams 422 comprise reflected scout pulses 424 and 426 from object 418 as well as a reflection of the primary pulse 428 from object 418. While shown as two scout pulses, a number of additional scout pulses of increasing intensity (power) may be transmitted and their reflections detected without departing from the scope of the technology described herein.

Detector 408 determines if its light detecting element reaches saturation when detecting the reflected primary pulse 428. When it is determined that the light detecting element reaches saturation, the system substitutes a first occurring (closest to primary pulse) non-saturating instance of the reflected scout pulses 424 and 426.

If the primary pulse saturates the detector, computing device 404 calculates a distance measurement for a detected object based on a nearest (to the reflected primary pulse) non-saturating instance of the reflected scout pulses 424 or 426. The distance measurement may, in one aspect, be adjusted based on calculating a time differential between a receipt time of the reflected primary pulse 428 and a receipt time of the non-saturating instance of the scout pulses. For example, at least one non-saturating instance of the scout pulses is determined based on analyzing the one or more first scout pulses by adjacency to the reflected primary pulse, wherein a closest adjacency is analyzed first. Having the time differential and the known speed of light of approximately c=3×10⁸ m/s, the computing device can calculate distances between pulses and incorporate distance adjustments accordingly based on a distance of a primary pulse to the actual pulse used in the analysis (e.g., first occurring non-saturated scout pulse). For example, if one primary pulse and one scout pulse are implemented with a time offset of 6 nanoseconds, and the scout pulse waveform is detected ahead of the primary pulse saturation region located ˜6 nanoseconds later in the histogram, the time-of-flight of the detected scout pulse will need to be calibrated forward by 6 nanoseconds. In this case, the round trip range offset between the scout pulse and the primary pulse is equivalent to a 1 meter LiDAR range correction factor (6×10⁻⁹ s/3×10⁸ m/s/2=1 m).

In addition, while computing device is shown local to vehicle 402, computing responsibilities may be handled locally, remotely by remote server systems, such as cloud processing systems, or be shared by the local and remote computing resources. One skilled in the art will appreciate that other computer processing approaches may be used or are contemplated within the scope of the technology described herein.

Transmitter 406 transmits each of pulses 412, 414 and 416 with pulse durations, in some embodiments, between hundreds of picoseconds and tens of nanoseconds (e.g., time-of-flight LiDARs). In one embodiment, the pulse duration of the scout pulses may be less than or equal to the pulse duration of the primary pulse because, in one aspect, it may be advantageous to use shorter pulse durations and easier to generate lower energy pulses with short durations, especially for diode lasers.

For Geiger-mode LiDARs, pulse frequency is typically on the order of ˜1 kHz to ˜1 MHz, while linear-mode LiDARs may vary between ˜10 Hz to ˜1 MHz. The lower end of these pulse frequencies may be associated with non-scanning flash LiDARs. One skilled in the art will recognize that the pulse width of pulses 412, 414 and 416 and the repetition rate of transmitter 406 are matters of design and that these pulses may have any suitable values.

In the illustrative embodiment, the repetition rate of transmitter 406 is based on the desired maximum range of detection, Lmax 420, in a detection field. In a non-limiting example, transmitter 406 transmits a train (sequence) of pulses along axis 410 at a repetition rate of 3.3 microseconds, which is based on the time-of-flight for a photon travelling to and from an object that is at a maximum detection distance, which is approximately 500 meters from receiver 406. This time-of-flight also determines the duration of each of a plurality of detection frames for system 400.

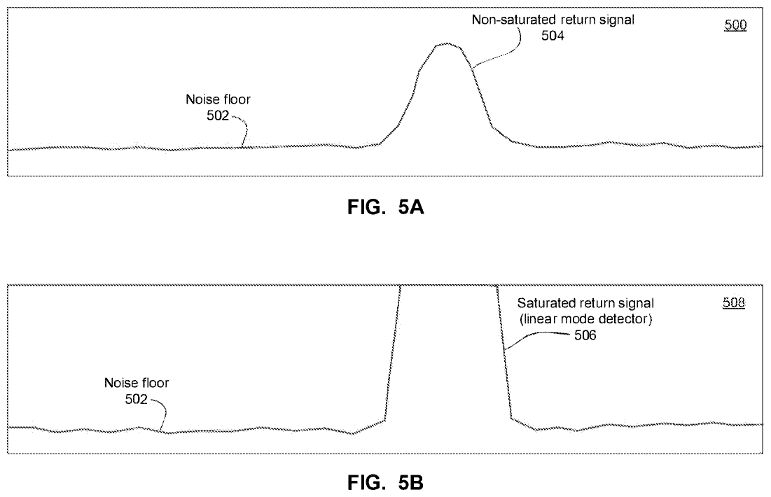

FIG. 5A illustrates a return signal waveform histogram 500 generated by a linear-mode Avalanche PhotoDiode (APD) with a non-saturated return signal (reflected) 504, according to some embodiments. An APD is a highly sensitive semiconductor photodiode detector that exploits the photoelectric effect to convert light into electricity. For a linear-mode APD, the waveform is clipped (magnitude held to a chosen max level), but the detector is not blinded after saturation (reset). For example, if a reflected waveform includes an intensity that saturates the APD, it will be clipped at a certain magnitude and the detector reset to detect the next pulse. As shown, a noise floor 502 is established for ambient reflected noise. The noise floor is estimated by signal processing algorithms, as is known, and may be used to modify the threshold amplitude required to detect return signals. A detected non-saturated return signal (reflected) 504 has an amplitude less than the clip magnitude-allowing computing device 404 to process a full LiDAR pulse analysis (e.g., distance and intensity determination).

Table 1 illustrates a non-limiting example return signal histogram generated by a LiDAR sensor with a non-saturated waveform return, according to some embodiments.

TABLE 1

| Target Type | Intensity Factor |
|---|---|
| Black Car | ~0.003 |
| Diffuse Target | <1 |
| Engineer Grade Retroreflector | ~100 |
| Diamond Grade Retroreflector | ~3000 |

In some embodiments, return signal intensity varies depending on the target reflectance, angle, and distance. The relative intensity between a diamond grade retroreflector and a surface with 0.3% diffuse reflectance (e.g. black car) is approximately 1,000,000:1. For a given target, return signal intensity is proportional to the inverse square of the distance, so the intensity ratio between a target at 3 meters and 100 meters is approximately 1,000:1, for example. As a result, an intensity dynamic range of ˜1E9 (90 dB) may be used to measure the intensity of a majority of targets at a majority of ranges relevant to terrestrial LiDAR systems. In some embodiments, Geiger-mode LiDAR (described in greater detail hereafter) is limited to ˜1E2 signal intensity dynamic range due to limited statistics and SNR.

FIG. 5B illustrates a return signal histogram generated by a linear-mode APD with a saturated waveform, according to some embodiments. For a linear mode APD, the waveform is clipped (magnitude held to a chosen max level), but the detector is not blinded after saturation (reset). For example, if a reflected waveform (pulse) includes an intensity that saturates the APD, it will be clipped and not included in the histogram (pulse values above a certain magnitude are not captured), and the detector will reset to detect the next pulse. As shown, a noise floor 502 is established for ambient reflected noise. A saturated return signal 506 has an amplitude greater than the clipped magnitude, thus preventing computing device 404 from processing a full LiDAR pulse analysis (e.g., distance and intensity determination).

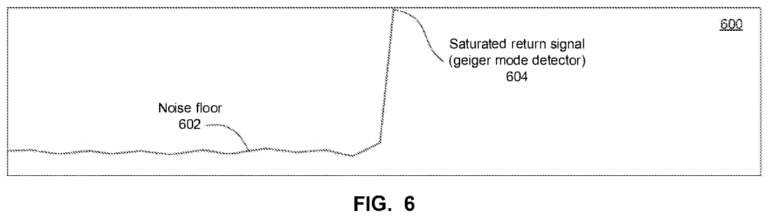

FIG. 6 illustrates a return signal histogram 600 generated by a Geiger-mode detector with a saturated waveform, according to some embodiments. Scout pulse detection for a Geiger-Mode APD scout pulse detector is slightly different from a linear-mode APD because waveform saturation blinds the detector (not reset before next pulse) from sensing photons at longer ranges. For example, if a reflected waveform (pulse) 604 includes an intensity that saturates the APD, it will not be clipped (pulse values above a certain magnitude) and histogram reflection values after saturation will not be included in the histogram. As shown, a noise floor 602 is established for ambient reflected noise. A detected reflected saturated pulse has an amplitude greater than the dynamic range of the detector, thus preventing computing device 404 from processing a full LiDAR pulse analysis (e.g., distance and intensity determination).

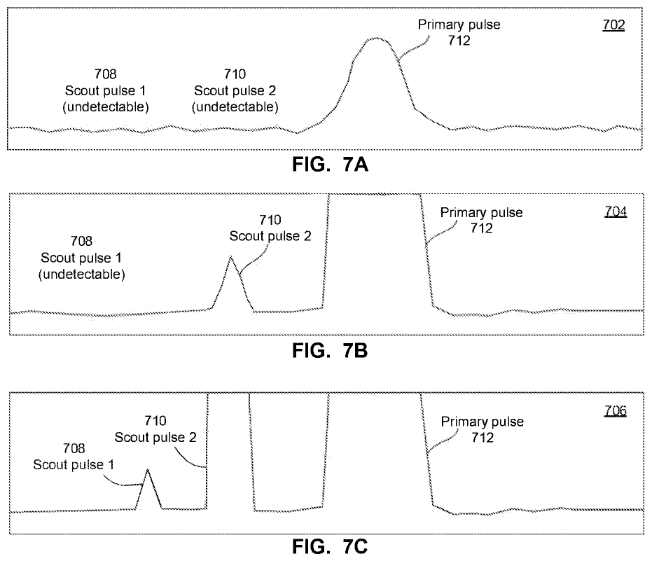

FIGS. 7A, 7B and 7C illustrate a histogram illustrating a sequence of reflected pulses as detected by a linear-mode APD. Continuing with the example shown in FIG. 4, two reflected scout pulses and a primary reflected pulse are shown in a histogram as detector 408 receives them. In these sequences, the detector may experience one or more pulses saturating the detector as will be described in greater detail below.

FIG. 7A illustrates a return signal histogram 702 with a non-saturated primary waveform, according to some embodiments. As shown, detected primary pulse 712 does not saturate the detector. As the detected reflected pulse is non-saturating (having an amplitude less than the clip magnitude), computing device 404 may process a full LiDAR pulse analysis (e.g., distance and intensity determination). In addition, in this scenario, since the primary pulse is non-saturating, the secondary pulses are not needed to analyze this reflected set of pulses. As shown, reflected scout pulse 1 (708) and reflected scout pulse 2 (710) are undetectable as the reflection intensity of the collective set is low (non-saturating) indicating that a target object is not of a highly reflective surface.

FIG. 7B illustrates a return signal histogram 704 with a saturated primary pulse waveform and non-saturated secondary pulses, according to some embodiments. As the primary pulse 712 is saturated, the closest scout pulse to the primary pulse, in the sequence of pulses, is analyzed by computing device 404. If this scout pulse is also saturated (e.g., as shown in FIG. 7C), the system selects the next scout pulse in the sequence (moving highest intensity to lowest intensity). As a result, scout pulse disambiguation may include the signal processing algorithms processed by computing device 404 to calculate a time delta between the detected waveform and the saturation region (if present). This time delay can be compared to a known time delay (e.g., dt1 or dt2 as shown in FIG. 4) between each pulse in the sequence to determine which non-saturated scout pulse was detected (and used in the calculations of distance and intensity).

FIG. 7C illustrates a return signal histogram 706 with a saturated primary pulse waveform, a saturated first occurring scout pulse and a non-saturated second scout pulse, according to some embodiments. As previously described, if the primary pulse 712 is saturated, the system looks to the closest non-saturated scout pulse relative to the primary pulse. However, if this closest scout pulse 710 (scout pulse 2) is also saturated, the system selects the next scout pulse 708 (scout pulse 1) in the reflected sequence. For example, the system would continue to analyze a sequence of scout pulses until reaching a first non-saturated instance. When saturation is detected, the signal processing algorithms may attempt to detect a non-saturating scout pulse waveform, which is known to be a fixed time offset from the primary pulse. If no scout pulse is detected, it may mean that either the primary pulse is saturated but the scout pulses are undetectable, or the scout pulses themselves have saturated.

As a result, the disambiguation of which scout pulse is being observed (and used in the calculations) can be determined by simply counting the number of saturation regions. As a result, scout pulse disambiguation requires the signal processing algorithms processed by computing device 404 to calculate a time delta between the detected waveform and the saturation region (if present). This time delay can be compared to a known time delay (e.g., dt1 or dt2 as shown in FIG. 4) between each pulse in the sequence to determine which scout pulse was detected.

In more complex configurations, there may be any number of scout pulses. To differentiate between multiple scout pulses, in one aspect, the offset time between adjacent scout pulses may be coded so that the scout pulse identity can be inferred from the time delta between the scout pulse centroid and the rising edge of the saturation region.

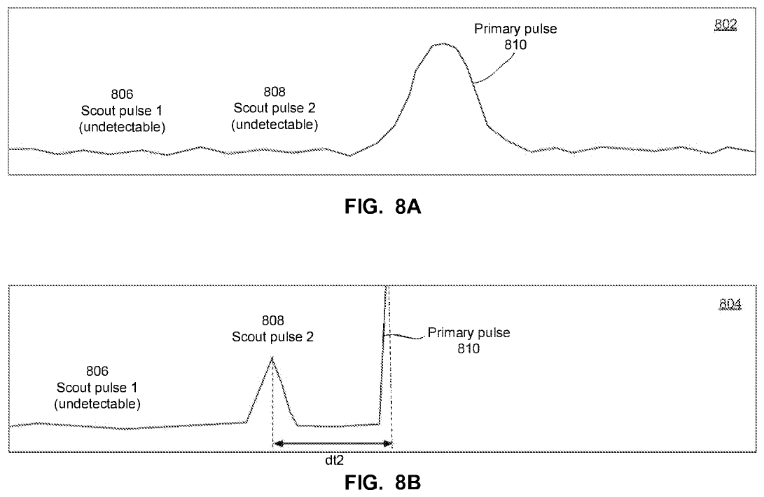

FIG. 8A illustrates a histogram 802 of scout pulse detection for a Geiger-mode APD, as per some embodiments. Scout pulse detection for a linear-mode APD is different from a Geiger-mode APD (GMAPD) because saturation does not blind the detector from observing future light. FIG. 8A illustrates a GMAPD Case 1 where a waveform (primary pulse 810) is detected with no saturation, according to some embodiments. As detected reflected pulse 810 is non-saturating, having an amplitude less than the detector's dynamic range, computing device 404 may process a full LiDAR pulse analysis (e.g., distance and intensity determination). As the primary pulse is non-saturating, the secondary pulses are not needed in this instance to analyze the reflected set of pulses. As shown, reflected scout pulse 1 (806) and reflected scout pulse 2 (808) are undetectable as the reflection intensity of the collective set is low (non-saturating) indicating that a target object is not of a highly reflective surface.

FIG. 8B illustrates a histogram 804 of scout pulse detection for a Geiger-mode APD, as per some embodiments. FIG. 8B illustrates a GMAPD Case 2, where a waveform (primary pulse 810) is detected as saturated. As the primary pulse is saturated, the closest scout pulse 808 (scout pulse 2) to the primary pulse (time delay dt2), in the sequence of reflected pulses, is analyzed by computing device 404. If this scout pulse is also saturated, the system selects the next scout pulse in the sequence (moving highest intensity to lowest intensity). As a result, scout pulse disambiguation may include signal processing algorithms processed by computing device 404 to calculate a time delta between the detected waveform and the saturation region (if present). This time delay can be compared to a known time delay (e.g., dt2) between each pulse in the sequence to determine which scout pulse was detected.

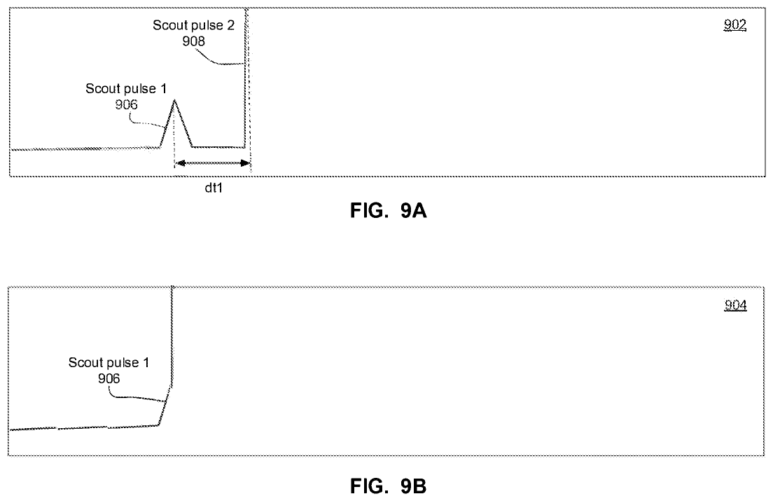

FIG. 9A illustrates a return signal histogram generated by a Geiger-mode detector with a saturated primary pulse waveform, saturated secondary pulse and non-saturated second secondary pulse, according to some embodiments. FIG. 9A illustrates a GMAPD Case 3 where a scout waveform 906 (scout pulse 1) is detected with a saturated region at dt1 from saturated waveform 908 (scout pulse 2), according to some embodiments. FIGS. 9A and 9B assume the primary pulse is saturated and therefore is not captured in the GMAPD histograms 902 and 904. As previously described, if the primary pulse is saturated, the system looks for the closest scout pulse to the primary pulse. However, if this closest reflected scout pulse (908—scout pulse 2) is also saturated, the system selects the next reflected scout pulse 906 (scout pulse 1) in the reflected sequence. For example, the system continues to analyze a sequence of scout pulses until reaching a first non-saturated instance. In the case where saturation is detected, the signal processing algorithms attempt to detect a non-saturating scout pulse waveform, which is known to be a fixed time offset from the primary pulse. The system will observe the saturated waveform closest to the non-saturated waveform to recognize a time delay (between saturated and first non-saturate waveforms) to determine which non-saturated pulse is being used to make the calculations of distance and intensity of reflected objects.

As a result, the disambiguation of which scout pulse is being observed can be determined by counting the number of saturation regions. As a result, scout pulse disambiguation requires the signal processing algorithms processed by computing device 404 to calculate a time delta between the detected waveform and the saturation region (if present). This time delay can be compared to a known time delay (e.g., dt1 or dt2 as shown in FIG. 4) between each pulse in the sequence to determine which scout pulse was detected.

If no scout pulse is detected, it can mean one of two things—either the primary pulse is saturated, but the scout pulse is undetectable, or the scout pulse(s) are also saturated.

In more complex configurations, there may be any number of scout pulses. To differentiate between multiple scout pulses, in one aspect, the offset time between adjacent scout pulses may be coded so that the scout pulse identity can be inferred from the time delta between the scout pulse centroid and a rising edge of the saturation region.

FIG. 9B illustrates a return signal histogram generated by a Geiger node detector with a saturated primary pulse waveform, a first saturated secondary pulse, and a second saturated secondary pulse, according to some embodiments. FIG. 9B illustrates a GMAPD Case 4, where no adjacent saturated/non-saturated waveforms are detected, anywhere in the data, according to some embodiments. In this configuration, all of the waveforms (primary and secondary pulses) are saturated. As shown, only a partial detection of scout pulse 1 is detected. In this scenario, scout pulse 1 (906) may be used in the calculations. In an alternative aspect, this pulse sequence is ignored and additional scout pulses (of lower power) are transmitted in the next sequence and this method repeats until a non-saturated pulse is detected. In another alternative aspect, this pulse sequence is ignored and the total number of scout pulses (e.g., three or more) is increased and transmitted in the next sequence and this method repeats until a non-saturated pulse is detected. For example, a larger sequence of scout pulses may include one with a low enough power level to not cause saturation of the detector.

FIG. 10A illustrates a single transmitter configuration 1002, according to some embodiments. Using a single transmitter 1006 may include a driver circuit 1008 capable of generating a fast sequence of current pulses (scout pulses 412, 414 and primary pulse 416) with increasing amplitude, and a laser with sufficient characteristics to support the desired intensity ratio and timing offset between adjacent pulses. It is beneficial to use a single transmitter because it guarantees the pulses will be aligned to the same propagation direction (axis), but in practice it may be difficult to achieve such a large dynamic range (>100) required by scout pulsing.

FIG. 10B illustrates multiple transmitters 1012, 1014 and 1016, according to some embodiments. Using multiple transmitters with electronically tunable time delays enables greater flexibility than a single transmitter design because each transmitter can be optimized for the intended scout pulse energy (by drivers 1008), and the time delay between each transmitter can be electronically reconfigured to any desired value. As shown, transmitter 1012 is a high-powered transmitter to transmit the primary pulse 416. Transmitters 1014 and 1016, successively require less power to transmit descending power/intensity scout pulses 414 and 412. If the transmitters are physically separated (as shown) or the beam propagation direction is slightly misaligned, this design may require external optical alignment and/or beam combining elements (not shown).

The additional Size, Weight, And Power (SWAP) required to drive scout pulse transmitter(s) may be negligible compared to the total system SWAP because the scout pulse energy is so small compared to the primary pulse. For a Geiger-mode LiDAR system, scout pulse energy is low enough that a single laser diode emitter can be used to illuminate an entire array of >1000 detector pixels.

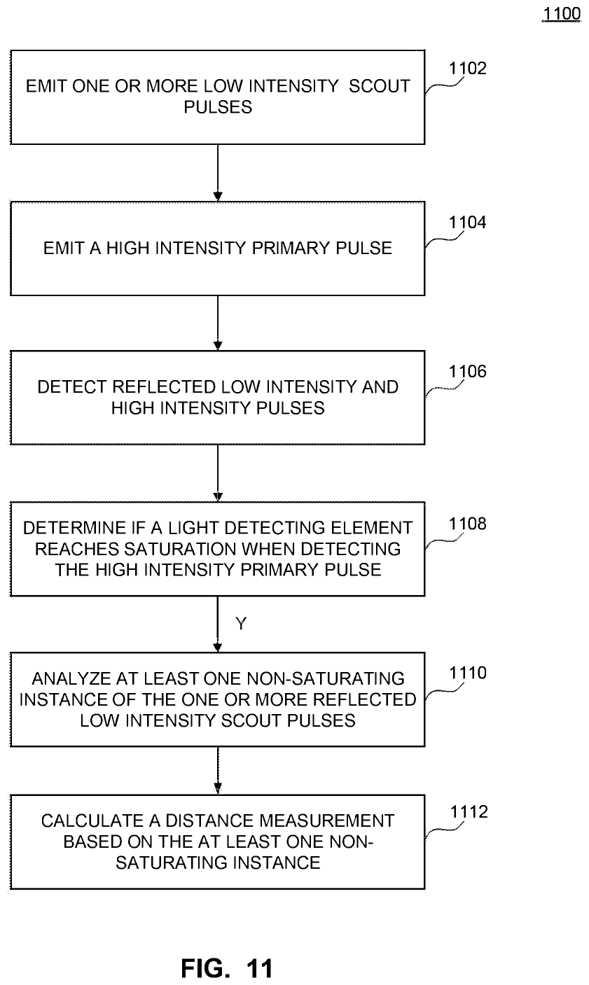

FIG. 11 is a flow diagram of primary and secondary pulse transmission and reflection processing, according to some embodiments.

In 1102, a light detection and ranging (LiDAR) device includes a first light emitting element (transmitter) operable to emit one or more scout pulses. In some embodiments, the one or more scout pulses may comprise multiple adjacent low intensity pulses configured with an intensity ratio between adjacent low intensity pluses substantially equal to a dynamic range of the light detecting element. The one or more scout pulses may comprise multiple adjacent pulses separated by a unique time delay, comprising a unique intensity and emitted in an order of ascending intensity (lowest intensity to highest intensity). In addition, an intensity dynamic range may be increased by a power of the number of the multiple adjacent scout pulses.

In 1104, a second light emitting element (transmitter) is operable to emit a high intensity primary pulse, where the high intensity primary pulse is emitted subsequent in time to the one or more scout pulses. In one aspect, the first light emitting element and the second light emitting element share a common transmitter with electronically tunable time delays to emit the one or more scout pulses and the high intensity primary pulse. In another aspect, the first light emitting element and the second light emitting element each comprise a separate transmitter with electronically tunable time delays to emit the one or more scout pulses and the high intensity primary pulse. In another aspect, the separate transmitters may be calibrated to match an intended energy of the scout and high intensity primary pulses and the tunable time delays between each transmitter may be electronically reconfigurable. In yet another aspect, the separate transmitters may be physically separated in a vertical plane and optically aligned by optical beam combining.

In 1106, a light detecting element is configured to detect reflected light beams. The reflected light beams may comprise at least the one or more scout pulses and the high intensity primary pulse (and some potential ambient noise).

In 1108, it is determined if the light detecting element reaches saturation when detecting the high intensity primary pulse. Saturation is a state in which a signal that is to be measured is larger than a dynamic range of the sensor (detector). When this happens, the output of the sensor becomes the limiting value of the sensor range and may be a source of considerable error between the true and estimated values during motion tracking.

In 1110, when determining that the light detecting element reaches saturation when detecting the high intensity primary pulse, the system analyzes at least one non-saturating instance of the one or more scout pulses. As previously described, the non-saturation instance is the first occurring (closest in the transmission sequence) scout pulse to the high intensity primary pulse.

In 1112, a distance measurement is calculated based on at least one non-saturating instance of the one or more scout pulses (first occurring non-saturated scout pulse). The distance measurement may, in one aspect, be adjusted based on calculating a time differential between a receive time of the high intensity primary pulse and a receive time of at least one non-saturating instance of the one or more scout pulses. For example, at least one non-saturating instance of the one or more scout pulses is determined based on adjacency to the primary pulse, wherein a closest adjacency is analyzed first. In one aspect, if the primary pulse is not detected (e.g., Geiger-mode), a time differential between a detected saturating scout pulse and an adjacent non-saturated scout pulse is used in calculating distance and intensity.

The technology described herein has many benefits. One benefit, range walk correction, is based on pulse intensity. For example, a range walk artifact in LiDAR data is one that causes higher intensity targets to appear at a closer range (forward range bias). There are several sources of error, which may contribute to range walk, but the most common causes are waveform distortion and saturation. Since scout pulses are many orders of magnitude lower intensity than the primary pulse, it is possible to use lasers with very short pulse durations, which are less susceptible to range walk errors. In the limiting case when the laser pulse duration is shorter than the time resolution of the detector, range walk effects should be nearly eliminated.

Another benefit is an increased upper bound of intensity dynamic range. The dynamic range of intensity measurements for a device, which utilizes scout pulsing, is theoretically bounded by the product of the dynamic range of the detector and the total number of pulses in the train. In many cases, it may be ideal for the intensity ratio between pulses to be slightly less than the full dynamic range of the detector to create a smoother transition between the scout pulse waveform and the saturation region caused by the lagging pulse.

Another benefit is full-scale reflectance calibration. In a LiDAR system with an intensity dynamic range less than approximately 1E6 (60 dB), it may not be possible to convert intensity data into reflectance across the full range of typically observable diffuse target reflectance (0.3% to 100%) and distance (˜1m to ˜200 m). Scout pulsing enables sufficiently high dynamic range that intensity data can be converted to reflectance without clipping high reflectance targets.

High intensity returns can introduce optical artifacts in which stray light propagates into neighboring pixels and increases the prevalence of false alarms. In principle, some types of artifacts caused by stray light can be deconvolved from LiDAR data, but it requires knowledge of the primary return signal intensity. If the primary return signal intensity is saturated and unmeasurable, it is not possible to reliably filter the source data.

An exemplary solution may not require any assumptions about the expected return signal intensity within a particular region of the field-of-view, and may be able to generate a non-saturated waveform with a dynamic range of at least 1E6 (60 dB) to cover the range of all possible targets at a single range, and at least 1E9 (90 dB) to cover the range of all possible targets at all possible ranges.

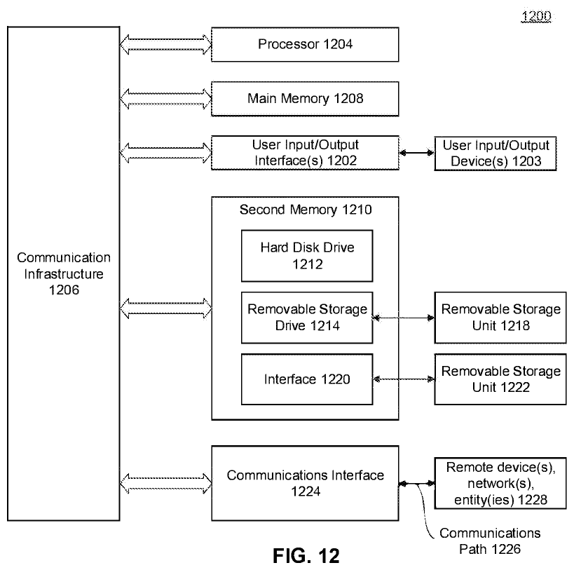

Various embodiments can be implemented, for example, using one or more computer systems, such as computer system 1200 shown in FIG. 12. Computer system 1200 can be used, for example, to implement method 1100 of FIG. 11. Computer system 1200 can be any computer capable of performing the functions described herein. In a non-limiting example, the computer may be an embedded processing system, a field-programmable gate array (FPGA) or an application-specific integrated circuit (ASICs).

Computer system 1200 can be any well-known computer capable of performing the functions described herein.

Computer system 1200 includes one or more processors (also called central processing units, or CPUs), such as a processor 1204. Processor 1204 is connected to a communication infrastructure or bus 1206.

One or more processors 1204 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1200 also includes user input/output device(s) 1203, such as monitors, keyboards, pointing devices, etc., that communicate with communication infrastructure 1206 through user input/output interface(s) 1202.

Computer system 1200 also includes a main or primary memory 1208, such as random access memory (RAM). Main memory 1208 may include one or more levels of cache. Main memory 1208 has stored therein control logic (i.e., computer software) and/or data.

Computer system 1200 may also include one or more secondary storage devices or memory 1210. Secondary memory 1210 may include, for example, a hard disk drive 1212 and/or a removable storage device or drive 1214. Removable storage drive 1214 may be a floppy disk drive, a magnetic tape drive, a compact disk drive, an optical storage device, tape backup device, and/or any other storage device/drive.

Removable storage drive 1214 may interact with a removable storage unit 1218. Removable storage unit 1218 includes a computer usable or readable storage device having stored thereon computer software (control logic) and/or data. Removable storage unit 1218 may be a floppy disk, magnetic tape, compact disk, DVD, optical storage disk, and/any other computer data storage device. Removable storage drive 1214 reads from and/or writes to removable storage unit 1218 in a well-known manner.

According to an exemplary embodiment, secondary memory 1210 may include other means, instrumentalities or other approaches for allowing computer programs and/or other instructions and/or data to be accessed by computer system 1200. Such means, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224. Communication interface 1224 enables computer system 1200 to communicate and interact with any combination of remote devices, remote networks, remote entities, etc. (individually and collectively referenced by reference number 1228). For example, communication interface 1224 may allow computer system 1200 to communicate with remote devices 1228 over communications path 1226, which may be wired and/or wireless, and which may include any combination of LANs, WANs, the Internet, etc. Control logic and/or data may be transmitted to and from computer system 1200 via communication path 1226.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 12. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A light detection and ranging (LiDAR) device, comprising:
a first light emitting element operable to emit one or more low intensity light beams;
a second light emitting element operable to emit a high intensity light beam, wherein the high intensity light beam is emitted subsequent in time to the one or more low intensity light beams;
a light detecting element configured to detect reflected light beams, the reflected light beams comprising one or more first reflected light beams and a second reflected light beam, wherein the one or more first reflected light beams comprise reflections of the one or more low intensity light beams and the second reflected light beam comprises a reflection of the high intensity light beam;
a processor configured to:
in response to determining that the light detecting element reaches saturation when detecting the second reflected light beam, analyze at least one non-saturating instance of the one or more first reflected light beams; and
calculate a distance measurement based on the at least one non-saturating instance of the one or more first reflected light beams.

2. The LiDAR device of claim 1, wherein the processor is further configured to:
adjust the distance measurement based on calculating a time differential between a receive time of the second reflected light beam and a receive time of the at least one non-saturating instance of the one or more first reflected light beams.

3. The LiDAR device of claim 1, wherein the processor is further configured to:
determine the at least one non-saturating instance of the one or more first reflected light beams based on analyzing the one or more first reflected light beams by adjacency to the second reflected light beam, wherein a closest adjacency is analyzed first.

4. The LiDAR device of claim 1, wherein the one or more low intensity light pulses comprises:
multiple adjacent low intensity light pulses configured with an intensity ratio between adjacent low intensity pluses substantially equal to a dynamic range of the light detecting element.

5. The LiDAR device of claim 1, wherein the one or more low intensity light pulses comprises:
multiple adjacent low intensity light pulses separated by a unique time delay, a unique intensity and an order of ascending intensity, lowest intensity to highest intensity.

6. The LiDAR device of claim 1, wherein an intensity dynamic range of the light detecting element increases by a power of the number of the multiple adjacent low intensity light pulses.

7. The LiDAR device of claim 1, wherein the first light emitting element and the second light emitting element share a common transmitter with electronically tunable time delays to emit the one or more low intensity light beams and the high intensity light beam.

8. The LiDAR device of claim 1, wherein the first light emitting element and the second light emitting element comprise:
a separate transmitter with electronically tunable time delays to emit the one or more low intensity light beams and the high intensity light beam.

9. The LiDAR device of claim 8, wherein the separate transmitters are calibrated to match an intended low intensity light beam pulse energy and the tunable time delays between each transmitter is electronically reconfigurable.

10. The LiDAR device of claim 8, wherein the separate transmitters are physically separated in a vertical plane and further comprise optical alignment.

11. The LiDAR device of claim 10, wherein the optical alignment comprises:
optical beam combining.

12. A light detection and ranging (LiDAR) system, comprising:
a light emitting transmitter operable to emit light beams and configured to:
emit one or more first intensity light beams;
emit a second intensity light beam, wherein the second intensity light beam is emitted subsequent in time to the one or more first intensity light beams;
a light detector operable to detect reflected light beams and configured to:
detect one or more first reflected light beams, wherein the one or more first reflected light beams comprise reflections of the one or more first intensity light beams;
detect a second reflected light beam, wherein the second reflected light beam comprises a reflection of the second intensity light beam;
a computing device configured to:
in response to determining that the light detector reaches saturation when detecting the second reflected light beam, analyze a first occurring non-saturating instance of the one or more first reflected light beams, wherein the first occurring non-saturating instance is based on detecting a closest reflected occurrence, to the second reflected light beam, of the non-saturating instance of the first reflected light beams; and
calculate a distance measurement based on the analyzing of the first occurring non-saturating instance of the one or more first reflected light beams.

13. The LiDAR system of claim 12, wherein the computing device is further configured to:
adjust the distance measurement based on calculating a time differential between a receive time of the second reflected light beam and a receive time of the first occurring non-saturating instance of the one or more first reflected light beams.

14. The LiDAR system of claim 12, wherein the computing device is further configured to:
adjust the distance measurement based on calculating a time differential between a receive time of the second reflected light beam and a closest, in time, one of the at least one non-saturating instance of the one or more first reflected light beams.

15. The LiDAR system of claim 12, wherein the one or more low intensity light pulses comprises:
multiple adjacent low intensity light pulses separated by a unique time delay, unique intensity and an order of emission of ascending intensity, lowest intensity to highest intensity.

16. The LiDAR system of claim 12, wherein the light emitting transmitter further comprises:
a plurality of separate light emitting transmitters with electronically tunable time delays to emit the one or more first intensity light beams and the second intensity light beam.

17. A method of measuring distance comprising:
emitting, using a first light emitting element, one or more low intensity light beams;
emitting, using a second light emitting element, a high intensity light beam, wherein the high intensity light beam is emitted subsequent in time to the one or more low intensity light beams;
detecting, using a light detecting element, reflected light beams comprising one or more first reflected light beams and a second reflected light beam, wherein the one or more first reflected light beams comprise reflections of the one or more low intensity light beams and a second reflected light beam comprises a reflection of the high intensity light beam;
in response to determining that the light detecting element reaches saturation when detecting the second reflected light beam, analyzing, by the computing device, at least one non-saturating instance of the one or more first reflected light beams; and
calculating, by the computing device, a distance measurement based on the at least one non-saturating instance of the one or more first reflected light beams.

18. The method of claim 17, further comprising:
adjusting, by the computing device, the distance measurement based on calculating a time differential between a receive time of the second reflected light beam and a receive time of the at least one non-saturating instance of the one or more first reflected light beams.

19. The method of claim 18, further comprising:
determining, by the computing device, the at least one non-saturating instance of the one or more first reflected light beams based on analyzing the one or more first reflected light beams by adjacency to the second reflected light beam, wherein a closest adjacency is analyzed first.

20. The method of claim 17, wherein the one or more low intensity light pulses comprise multiple adjacent low intensity light pulses, and the method further comprises:
separating the multiple adjacent low intensity light pulses by a unique time delay, unique intensity and order of ascending intensity, lowest intensity to highest intensity; and
adjusting the distance measurement based on calculating a time differential between a receive time of the second reflected light beam and a receive time of the at least one non-saturating instance of the one or more first reflected light beams.
